(19) United States
(12) Patent Application Publication
(10) Pub. No.: US 2014/0379585 A1
(43) Pub. Date: Dec. 25, 2014

(54) ELECTRONIC SIGNATURE SYSTEM FOR AN ELECTRONIC DOCUMENT USING A PAYMENT CARD

(71) Applicant: AliasLab S.P.A., Milano (IT)

(72) Inventors: Gianluca Buelloni, Mantova (IT); Romeo Magagnotti, Mantova (IT)

(21) Appl. No.: 14/313,277

(22) Filed: Jun. 24, 2014

(30) Foreign Application Priority Data
Jun. 25, 2013 (IT) RM2013A000363
Jun. 25, 2013 (IT) RM2013A000364

(51) Int. Cl. G06Q 20/38; G06Q 20/02; G06Q 20/20; G06Q 20/34

(52) U.S. Cl. CPC G06Q 20/3825; G06Q 20/34; G06Q 20/02; G06Q 20/204
USPC 705/76

(57) ABSTRACT

A system for the advanced electronic signature of an electronic document by a user, wherein a signature certificate is held by a third-party Authority, provided to sign said electronic document, the electronic document comprising an authentication field adapted to contain a set of signature data (blob), the method comprising an authentication step of the user at said Authority, by means of a third-party authentication circuit such as a bank circuit and/or a mobile phone channel, an acquisition step of a unique identifier ID associated to the user by said third-party authentication circuit, and an input step of said unique identifier (ID) in said set of signature data by said Authority.

### FIELD OF THE INVENTION

The present invention relates to an electronic signature system, in particular in the field of advanced electronic signature.

### BACKGROUND ART

Electronic signature processes have long been known. Essentially, they have been created to ensure authenticity of the signature affixed to an electronic document and integrity of the electronic document signed.

Electronic signature is defined by the European Directive 1999/93/EC: “electronic signature” means “data in electronic form which are attached to or logically associated with other electronic data and which serve as a method of authentication”.

Advanced electronic signature with qualified certificate is a type of advanced electronic signature, wherein there is provided the use of a pair of asymmetrical digital keys, of which one private key is attributed uniquely to a subject, referred to as holder, and one corresponding public key to verify the authenticity of the signature.

In such context the concept of “qualified certificate” is defined, cf. art. 2, par. 10 European Directive 1999/93/EC, as “an electronic attestation which links signature-verification data to a person and confirms the identity of that person”. Document WO03015370 shows a so-called “out-of-band” solution, wherein in order to improve the security of communication between the source of the document to be signed (user's computer) and the certification server, an additional channel is used, such as for example a telephone line, to which a “token” is sent containing a one-time password generated at the server end. The use of the password received by means of a telephone line therefore contributes to uniquely identify the signatory. The context of such document, however, relates to the association of a private key to each signatory.

Besides the digital signature with qualified certificate as defined above, there is provided a second type of electronic signature, the so-called “advanced electronic signature” wherein a signature certificate is not required for each signatory. Such is the electronic signature meeting the following requirements: a) being uniquely linked to the signatory; b) being capable of identifying the signatory; c) being created using means that the signatory can maintain under his sole control; d) being linked to the data to which it relates in such a manner that any subsequent change of the data is detectable.

The digital signature with qualified certificate therefore represents a more restrictive case of advanced electronic signature.

In the context of advanced electronic signature, in fact, it is not mandatory for the single signatory to have a signature certificate and private key thereof for signing a document.

Both the public key and the private key used to complete the signing process of the document in fact belong to the entity or authority supervising/managing the advanced electronic signature process.

The above-mentioned pair of public and private keys may therefore be used by the authority, for all the signatory users and for all the signatures.

Such scenario is particularly suitable for those corporate environments in which it is necessary for documents to be signed electronically, by multiple employees, however without the need for each of them to be provided with a digital signature device with a qualified certificate.

However it is complicated to ensure the identification of the signatory inside a company in which the signatories may potentially be hundreds.

Such problem is also felt in the field of the digital signature itself, in that is known and recognized, the practice of managers, who have digital signature devices with qualified certificate, of leaving the signature device in the hands of their collaborators, who may fraudulently make use thereof.

### SUMMARY OF THE INVENTION

An object of the present invention is to provide an advanced electronic signature system adapted to solve the above-mentioned problem, while ensuring in a safe way the identity of the person authorizing the signature.

An object of the present invention is a method for the advanced electronic signature of an electronic document by a user, in accordance with claim 1.

A preferred implementation of the present method uses two different data connections.

Another preferred implementation of the present method uses two different data connections and a mobile phone service. In such circumstance, such implementation may be defined out-of-band.

According to a first aspect of the invention, an ID of the bank card or associated thereto, uniquely associated to the user involved in the signature procedure and/or a telephone ID uniquely associated to the mobile phone line of the user involved in the signature procedure is directly imprinted in the signed document.

According to a preferred variant of the invention, a set of data, referred to as blob, is entered in a safe way inside the document in the signing step, so as to make the extraction and use of any portion thereof in other documents impossible. Said blob comprises an ID relating to a bank card or to an authorization procedure of a transaction executed by a bank card, wherein the bank card is associated to the user.

According to the present invention, such ID may be one or more of
ID or PAN of the bank card,
IBAN or similar unique code of the bank account associated to the bank card,
any unique transaction identifier generated during the use of the same bank card, at least in one authorization step for a bank transaction.

Such bank authorization has to be performed during the authentication relating to the same advanced electronic signature.

The fact that, by means of said bank card, an authorization for a transaction is determined, does not imply that then a transaction will actually take place. What matters, if it is desired to enter a transaction ID in the signature blob, is that an authorization procedure is started, by means of which a unique transaction identifier associated to such bank card is obtained.

Therefore, the authorization procedure for a transaction may per se be known.

In addition, one of the following data may optionally be entered: time of transaction, a transaction ID, ID of the bank terminal, retailer ID, acquirer ID, that is the ID of the Company managing the authorizations of the Bank cards, any amount, even symbolic, of the transaction.

In the context of the present description, bank transaction means any transaction performed with a bank card, such as for example, debit, recharge and/or authorization and/or pre-authorization and/or reversal.

According to a variant of the present invention, the bank transaction is not used to allow money transfer, but the same transaction is an integral part of the authentication process, and especially of the process of advanced electronic signature, the authorization techniques for bank transactions being per se secure.

According to a further variant of the invention, alternatively or in combination with the preceding one, a phone ID uniquely associated to the mobile phone line of the user is entered in the blob in order to further increase the level of security as regards the identification of the signing user and there may optionally be provided for the signing user to establish a phone call by means of a mobile phone network which provides for the retrieval of a further code among the following:
the mobile phone number associated to the user,
the IMSI associated to such mobile phone line,
the MSISDN.

Other codes associated to the establishment of a mobile phone connection may be used in this context and for the purposes described.

In addition, also the IMEI of the user's mobile device may be imprinted in the electronic document to be signed.

All the foregoing acronyms are well known.

In addition, one of the following data may optionally be entered: time of call, a session identifier, a one-time password.

In the context of the present description, call means any voice call or, for example, USSD (Unstructured Supplementary Service Data).

According to the present invention, the additional, external, channel is not only used to allow entering a password, but it becomes an integral part of the authentication process, and especially of the process of advanced electronic signature, the GSM/UMTS/LTE technology being per se extremely secure.

According to a preferred variant of the invention, such blob, containing said user ID, is encrypted by means of an encryption algorithm using a random key. The same random key is encrypted by means of a public key of an asymmetrical pair belonging to the Authority. Both the encrypted blob and the key encrypted by means of the public key are entered in the electronic file to be signed. Therefore a first object is achieved. Subsequently, a sign (hash) of the file obtained at the previous step is calculated by a predefined algorithm and with the same predefined algorithm a sign (hash) of the blob is calculated. The two signs obtained are linked or not and encrypted by means of the above-mentioned encryption algorithm using the above-mentioned random key. A second object is achieved. The first and the second object are connected to each other, for example linked together, or embedded in a further object. The fact of having a sign of the document to be signed including the encrypted blob and the encrypted sign of the blob separately allows ensuring that a specific blob is paired to a specific document avoiding that an encrypted blob may be extracted from an original document to fraudulently enter it in another document.

According to the present invention, the signature is authorized at least when a bank transaction is authorized with the card associated to the user so as to verify the identity of the user. Thus, at least one of the above-mentioned IDs of the signature blob is included.

The bank authorization process may per se require the user to enter a related PIN, as per se known, therefore in the course of a signature of a document entering one or more PINs may be required.

Entering a one-time password may also be requested, for example received by means of a data connection or by means of a phone connection on a mobile network and used by the user, correspondingly by means of the mobile network or the data connection.

According to a preferred variant of the invention, the signature is authorized when a phone call is made/received by means of the mobile phone number associated to the user to verify the identity of the user not only by means of his/her own phone number, but also by entering a personal PIN and/or a one-time password sent through the Internet.

According to a preferred variant of the invention, the one-time password and/or personal PIN may be sent via the mobile phone network on the user's mobile device.

It is apparent that the system may be implemented on any computer network, even other than Internet.

According to a preferred variant of the invention, the phone call is started from the user's phone. According to another preferred variant of the invention, the phone call is started from the user's phone and is then terminated, so that the system recalls said number, optionally detecting the presence of call diversions, so as to increase the level of security of the operation.

It is therefore clear that the out-of-band connection by means of a mobile phone line does not only allow the unique identification of the user, but also a respective phone ID contributes to defining the blob entered in the document to be signed.

The following detailed description illustrates an example of technological system/infrastructure besides the mobile device of the user, for implementing the present invention.

Advantageously, no specific application installed on the user's mobile phone is needed, therefore even an obsolete GSM telephone may be used to perform a part of the above-described method.

The present invention finds particular application in the field of both advanced electronic signature and of digital signature with qualified certificate, in order to further increase their level of security.

It is another object of the present invention a network infrastructure, in accordance with claim 13, which allow achieving the above-described method.

The dependent claims describe preferred embodiments of the invention, forming integral part of the present description.

### BRIEF DESCRIPTION OF THE DRAWINGS

Further features and advantages of the invention will appear more clearly from the detailed description of preferred but non-exclusive embodiments of an advanced electronic signature system, illustrated by way of a non-limiting example with the aid of the accompanying drawing tables, wherein:

FIG. 1 shows a representative flow chart of a preferred variant of the electronic signature method according to the present invention,

FIG. 2 shows a time diagram of data exchange between physical entities involved in the electronic signature process according to the method of FIG. 1;

FIG. 3 shows a time diagram comprising further optional steps of the process described in FIG. 2.

The same reference numerals and letters in the figures identify the same elements or components.

### DETAILED DESCRIPTION OF A PREFERRED EMBODIMENT OF THE INVENTION

According to the present invention, inside the document to be signed there is entered a so-called blob containing, besides the personal data of the subject signing the document, also a unique ID associated to a bank card or to a bank transaction associated to a bank card associated to the signing user by means of which the authentication procedure of the same subject is performed, and/or also a mobile phone number, by means of which a further authentication procedure of the same user is performed.

It is worth reporting that the same paper receipts printed by a POS (Point-of-Sale) payment device include a lot of information among which at least one transaction ID. The authentication and authorization bank system stores such transaction ID besides the identifier of the bank card and the data of the holder for many years. Therefore, the entry of the card ID, but even better, of the ID of an authorization/transaction performed with a bank card in the signature data allow identifying the signing user in a virtually unique way.

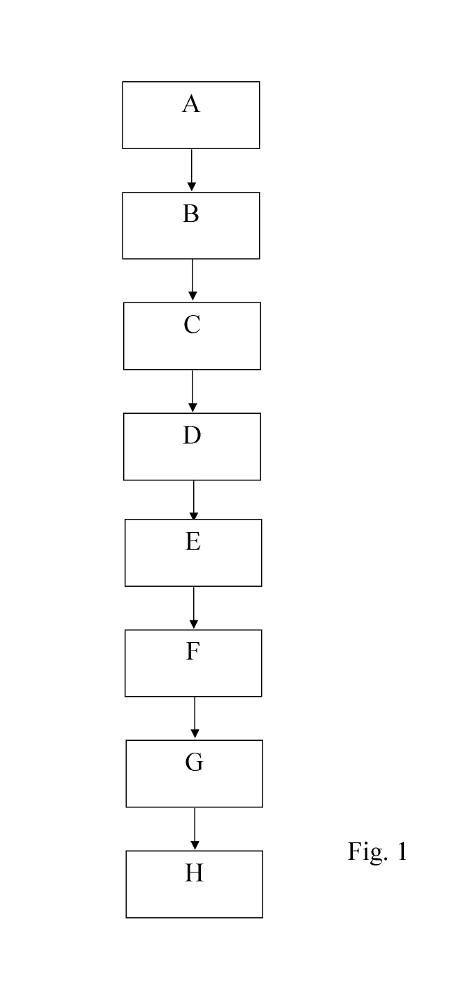

With reference to FIG. 1, a preferred variant of the electronic signature of a document, according to the present invention, comprises the following steps:

A. entry, in a file to be signed, generally in PDF format, of an authentication item/field which, according to some regulations, is entered in a so-called “signature dictionary”: (optionally) such step may be performed on a copy—previously made—of the document to be signed;

B. first encryption of a blob comprising authentication data of the signing subject, preferably by means of an AES algorithm and using a randomly generated key;

C. second encryption of the key used for the first encryption by means of a preferably RSA algorithm using a public key assigned to the authority managing the signature process;

D. first linking of the encrypted blob and of the encrypted key obtained in steps B and C and entry in said authentication item/field;

E. calculation of a first sign (hash), preferably by means of a SHA-256 algorithm of the whole document, including the above previously entered authentication item;

F. calculation of a second sign (hash), preferably by means of a SHA-256 algorithm, of the non-encrypted blob;

G. second linking of said first and second signs (obtained at steps E and F) and third encryption of the linking by means of said randomly generated key, and preferably by means of the same (AES) algorithm of step B.

H, the result of said third encryption is embedded in an object, preferably of the CAdES (ETSI TS 101 733) type encrypting the sign with the private key assigned to the Authority supervising/managing the signature process.

Said blob comprises an ID of the bank card or associated to a transaction, be it in terms of authorization, performed with a bank card uniquely associated to the user involved in the signature procedure and/or a telephone ID associated to the same phone line needed for the authentication of the user.

The aforementioned steps may be performed by a single computer or synergistically by a local computer and a remote server.

For example, according to a preferred variant of the invention, steps A-H are performed by a remote server. According to another variant, the remote server performs only steps G and H, while the local computer performs the remaining ones.

By way of example, the method may be summarized as follows:

1) the signing user is prompted to execute a transaction via a credit/debit/prepaid card;

2) preferably, a per se known device acquires biometric information of the user: such device may be a so-called bank POS and such biometric information may be a biometric signature, a digital sign, a voice recording or an iris scan of the user, etc.;

3) the user, concurrently, enters its bank card into the device, for example the same POS to perform a debit or pre-authorization/authorization transaction, which could require the entry of a specific authorizing PIN;

4) acquisition of at least one ID, be it of the bank card or associated to the card or associated to the transaction authorized/ordered with the same bank card;

5) optional acquisition of a further phone ID unique of the user obtained during an authorization session via mobile phone network;

6) entry of the ID(s) in the signature BLOB, to electronically sign a document (for example PDF).

It is apparent that the signing user uses a first data connection to a first remote signature server (Authority), a second data connection to a second bank server (Acquirer) for the authentication/authorization of a bank transaction.

A further data connection allows transferring said ID from said second server to said Authority (or first server) by means of the PC/local entity used by the user to request the signature of an electronic document, in order for the Authority to enter it in the above-mentioned signature blob.

Alternatively or in combination with the ID associated to a bank transaction, the system provides for the use of the unique mobile phone ID of the user.

According to the present invention, such ID may be one or more of
the mobile phone number associated to the user,
the IMSI associated to such mobile phone line,
the MSISDN,
the IMEI of the mobile device.

The blob, preferably, comprising at least one of the following further data: time of call, a session identifier, a one-time password.

The term “blob” is also well known in the scope of the present invention and derives from the acronym of the phrase “binary large object”.

The signature method described herein ensures, in a broad scope, that is, in which a single pair of asymmetrical keys in the Authority's possession is shared by multiple users, the identity of the signing subject, that is the user.

The method also allows a further increase in the level of security in the paradigms of electronic signature, in which, to each user a qualified certificate is associated. In addition, if a copy of the electronically signed document in advanced mode is suitably stored in a storage server, for example, of a third-party, it is possible at any time to uniquely and safely find the identity of the subject who has signed the document by means of a shared certificated, for example, with a corporate level.

In order for the signature of the document to be authorized, shown by means of the above-mentioned steps A-H, the signing subject is required to start a bank transaction by means of a bank card associated to him/her.

In order to increase the level of security, the user may be required to enter a signature PIN (optionally different from the PIN used in the authorization for the bank transaction) to be send to said first server by means of the above-mentioned first data connection.

In order to further increase the level of security, there may be provided the use of an out-of-band channel, that is different from the preceding data connections.

The user may be required to interact with his/her own mobile phone to enter said signature PIN. There may be provided for the user to receive a one-time password via the first data connection and enter it via his/her own mobile phone or vice versa.

Furthermore, the technological infrastructure, which may be schematized with the above-mentioned first remote server (Authority), may also provide for the verification that the phone number used by the user has previously been associated to him/her.

Alternatively, the signing subject may be required to dial a specific USSD number. To increase the security, the system may provide for the termination of the phone session started by the signing subject and then call back the same, so as to increase the security of the data exchange.

As a further option, the local application through which the electronic signature of a document is requested may allow specifying that the user is abroad or that any way he prefers to be called back. In such case, the system, that is, the remote server (Authority), will initialize a phone call to the mobile device of the user, optionally subjecting the successful completion of the signature procedure to a verification of the absence of a call diversion activated on the mobile phone number associated to the signing subject.

When the user is abroad, in fact, the phone number of the caller and/or his/her IMSI and/or MSISDN, etc. may be unavailable to the remote server, therefore it is advantageous that the server initializes the call.

According to a further preferred variant of the invention, instead of a phone call between a mobile device and a remote server, there may be implemented a phone connection by dialing USSD codes, for example a phone sequence of the *123*13# type.

According to the present invention, therefore, at least three hardware and four software entities are needed to implement the signature process, as explained hereinafter:
a first local electronic signature application, generally a software running on a PC or tablet or suitable device of the signing subject, by which it is possible to request the electronic signature of a document via a computer network,
a second local application provided with a reader of bank cards and optionally of biometric information; such application may run on the same PC or tablet as the previous point or on another per se known device. Furthermore, the first local application is capable of automatically acquiring, from the second local application, said ID associated to the bank card;
a first remote electronic signature application, associated to the Authority or electronic signature entity, to which an interface to the above-mentioned computer network towards said first application and optionally a landline or mobile phone interface are associated,
a second remote application associated to the second local application, per se known, to authorize a bank transaction by means of said bank card and adapted to generate a transaction or authorization ID associated to that specific bank card;
optionally a GSM/UTMS/LTE, etc. mobile phone associated to the signing subject (user).

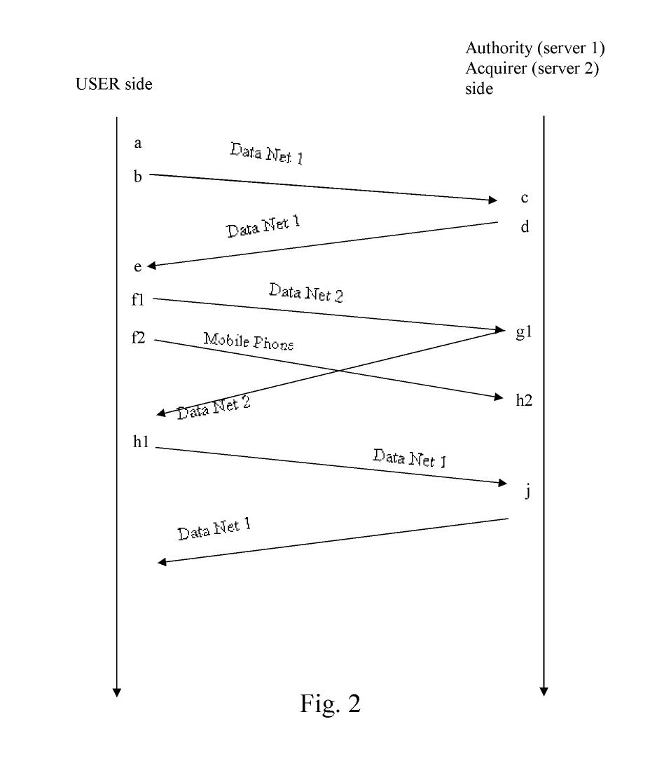

With the aid of FIG. 2 an example of signature process performed synergistically via a computer network and a bank computer network is illustrated in detail

a. (user end) generating a file to be electronically signed,

b. (user end) sending the file to be signed—via a first computer connection—to the signature Authority, i.e. to signature server at the Authority (also referred to as first remote server),

c. (Authority end, server 1) initializing an authentication session, optionally creating a one-time password,

d. (Authority end, server 1) sending a request in order for the user to authenticate on the bank circuit of the bank card associated to him/her, or to make a phone call to a predetermined phone number by means of a mobile phone previously associated to the user,

e. (user end) displaying said request, and

f1. (user end) requesting an authorization for performing a bank transaction by the bank card—via a second computer connection—for example by a POS connected to the PC on which the first and the second local application run, or an independent payment device comprising interface means with said PC in order for the PC to acquire said ID associated to the bank card and/or

f2; (user end) making a phone call by means of a mobile network to a predetermined phone number in relation to said server of said Authority,

g1. (Acquirer end, server 2) sending approval to execute said bank transaction to the user, in particular to the POS at the user's disposal, together with an identifier of the bank card and/or of the authentication procedure and/or of the bank transaction,

h1. (user end) sending said ID associated to the bank card to said signature server, at the Authority, via said first data connection;

h2. (Authority end, server 1) acquiring said ID associated to said mobile phone line of the user;

i. (Authority end, server 1) electronic signature of said document to be signed according to the above steps A-H according to claim 6, and

j. (Authority end, server 1) sending—via computer network—the signed electronic document.

Optionally, during or after said step i, there may be provided a storage of the electronically signed document. For example on a different storage server.

The references 1 and 2 of h1 or h2, for example, clearly indicate the two possibilities of obtaining a unique ID by means of a third-party authentication circuit. Therefore, only the steps marked with 1 or 2 or both may be performed.

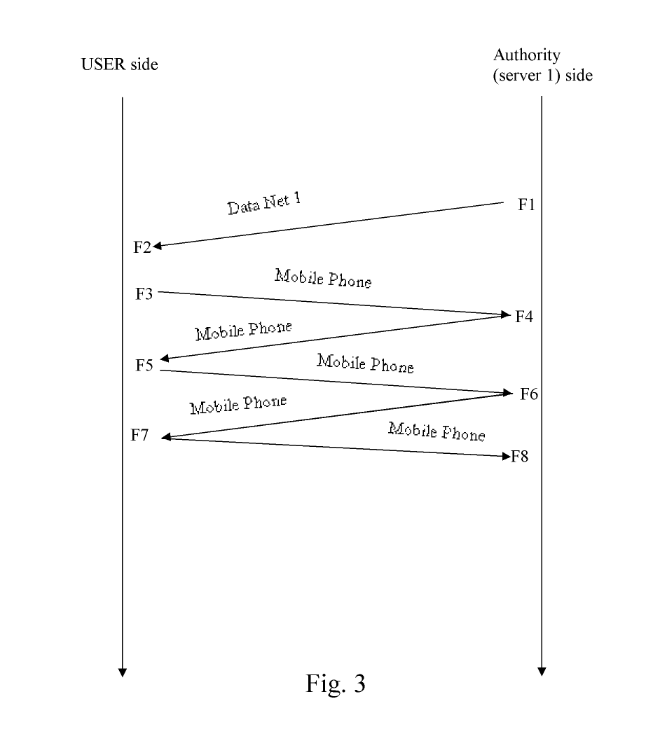

If also the out-of-band verification is provided, step f2, the method comprises the steps shown in FIG. 3, to be performed before, during or after steps d-h.

For convenience, they are indicated as f1-f8, but this only means that they are performed before step i of FIG. 2.

F1. (Authority end, server1) sending a phone number or reference phone sequence—via a computer network 1—and optionally said one-time password,

F2. (user end) displaying said phone number or reference phone service USSD and optionally said one-time password,

F3. (user end) sending a call to said authentication phone number or a service request to said authentication sequence—via a mobile phone network —,

F4. (Authority end, server1) optionally requesting the typing of said one-time password with mobile phone—via mobile phone network —,

F5. (user end) optionally typing said one-time password via mobile phone network—,

F6. (Authority end, server1) optionally requesting the typing of a PIN code associated to the customer—via mobile phone network —,

F7. (user end) optionally typing said PIN code—via mobile phone network —,

F8. (Authority end, server1) checking the association of said mobile phone ID to said user and optionally of said PIN and/or said one-time password.

According to a preferred variant of the technological infrastructure previously indicated as “Authority end, server 1” a set of different processing units may be understood.

For example, the interface operations with the mobile phone network may be managed by a dedicated authentication server connected, by means of a secure data connection, to the server, at the Authority, intended for electronically signing the electronic document, hereinafter “Signature appliance”.

For example, step c may be entirely performed by the authentication server upon explicit request of the Signature appliance server. Therefore, at step c the exchanges of requests and information between the Signature appliance server and the authentication server may be considered implicit.

Advantageously, the system described herein is particularly safe because it provides for the authentication to be performed by a bank computer and/or mobile phone network, that is inherently safe, wherein at least one identifier code associated to the bank card and/or phone number of the user is generated/acquired and entered to the blob. If both IDs are implemented, then the authentication is also performed by means of an “out-of-band” connection, that is by means of an associated mobile phone network, via which an identifier code associated to the mobile phone line of the user is entered to the signature blob of the document to be electronically signed.

Optionally also the same biometric information may be encrypted and entered to the signature blob.

A further increase in security may be achieved by providing for the phone number to be called, associated to the remote server, to be different in relation to the signature section.

Furthermore, the system may request the entry of both the PIN in the user's possession and the one-time password sent via the Internet. Therefore, the number of verification data is high, thus increasing the level of security.

According to a preferred variant of the invention, at step h3, after sending a call to the user via his/her mobile device, the call may be automatically terminated by the authentication server which immediately after calls back the mobile number of the user in order to obtain therefrom the one-time password and PIN as described at the following steps h4-h8.

This ensures immunity against fraudulent attacks.

The present invention may be advantageously achieved by means of computer program which comprises encryption means for performing one or more steps of the method, when this program is run on a computer. Therefore, it shall be understood that the scope of protection extends to said computer program and further to the computer-readable means comprising a recorded message, said computer-readable means comprising program encryption means for performing one or more steps of the method, when said program is run on a computer.

Embodiment variants of the non-limiting example described are possible, without however departing from the scope of protection of the present invention, comprising all the equivalent versions for a person skilled in the art.

From the foregoing description, the person skilled in the art is capable of achieving the object of the invention without adding further construction details. The elements and the features shown in the different preferred embodiments may be combined without departing from the scope of protection of the present application.

1. A method for the advanced electronic signature of an electronic document by a user, wherein a signature certificate is held by a third-party Authority, provided to sign said electronic document, the electronic document comprising an authentication field adapted to contain a set of data (blob) relating to the transaction/authentication, the method comprising an authentication step of the user at said Authority, by means of a third-party authentication circuit such as a bank circuit and/or a mobile phone channel, an acquisition step of a unique identifier ID associated to the user by said third-party authentication circuit, and an input step of said unique identifier (ID) in said set of signature data by said Authority.

2. A method according to claim 1, wherein said third-party circuit is a bank authentication circuit for authorizing a transaction by a credit or debit card and wherein said unique identifier ID coincides with a unique identifier or PAN of the bank card and/or an IBAN code associated to the bank card and/or a unique transaction identifier generated while using the same bank card, at least in one step of authorizing the execution of a bank transaction, required by the authentication procedure of the user during the signature procedure itself.

3. A method according to any of the preceding claims, wherein said unique identifier ID coincides with a unique identifier associated to said user by a mobile phone network by means of a mobile phone line associated to the user comprising one or more of
the IMSI associated to said mobile phone line,
the MSISDN associated to said mobile phone line.

4. A method according to claim 3, further comprising a step of entering in said set of signature data also one among
the IMEI of the user's mobile device,
a one-time password.

5. A method according to one of the preceding claims, further comprising a step of entering in said set of signature data also one among
authentication time,
an authentication session identifier,

6. A method according to any one of the preceding claims, comprising the following steps in a sequence:
A. entry of an authentication item/field in a file to be signed;
B. first encryption of a blob comprising authentication data of the signing user, by means of an AES algorithm and using a randomly generated key;
C. second encryption of the key used for the first encryption by means of a preferably RSA algorithm using a public key assigned to the signature Authority;
D. first linking of the encrypted blob and of the encrypted key obtained in steps B and C and entry in said authentication item/field;
E. calculation of a first sign (hash), including the above previously entered authentication item;
F. calculation of a second sign (hash), preferably by means of a SHA-256 algorithm, of the non-encrypted blob;
G. second linking of said first and second hashes (obtained at steps E and F) and third encryption of the linking by means of said randomly generated key, by means of the same AES algorithm of step B;
H, the result of said third encryption is embedded in an object, preferably of the CAdES (ETSI TS 101 733) type by encrypting the sign (hash) with the private key assigned to the signature Authority.

7. A method according to claim 6, wherein at least one of said signs (hashes) is obtained by means of an SHA-256 algorithm of the whole document.

8. A method according to any one of the preceding claims, wherein said authentication step includes:
a user's request to sign an electronic document towards said electronic signature Authority, sent via a first computer network,
the signing user is requested to perform a transaction by means of a credit/debit/prepaid card by means of a dedicated device (POS) and/or a phone call to a predetermined phone number;
optional acquisition of a user's biometric information via a dedicated device (POS),
acquiring said unique ID associated to the bank card or associated to the transaction authorized/ordered via the bank card itself, and/or associated to said mobile phone line
entering said unique ID in said set of signature data.

9. A method according to claim 8, wherein when biometric information is acquired by the signing subject during the authorization/authentication procedure of a bank transaction, said biometric information is integrated in said set of signature data.

10. A method according to one of the preceding claims, comprising the following steps in succession:
a. (user end) generating a file to be electronically signed,
b. (user end) sending the file to be signed—via a first computer connection—to the signature Authority,
c. (Authority end, server 1) initializing an authentication session, optionally creating a one-time password,
d. (Authority end, server 1) sending a request in order for the user to authenticate on the bank circuit of the bank card associated to him/her and/or on a mobile phone network by calling a predetermined phone number,
e. (user end) displaying said request, and
f1. (user end) requesting an authorization for performing a bank transaction by the bank card—via a second computer connection—for example by a POS connected to the PC on which the first and the second local application run, or an independent payment device comprising interface means with said PC in order for the PC to acquire said ID associated to the bank card and/or
f2; (user end) making a phone call by means of a mobile phone associated to said user to a predetermined phone number in relation to said server of said Authority,
g1. (Acquirer end, server 2) sending approval to execute said bank transaction to the user, in particular to the POS at the user's disposal, together with an identifier of the bank card and/or of the authentication procedure and/or of the bank transaction,
h1. (user end) sending said ID associated to the bank card to said signature server, at the Authority, via said first data connection;
h2. (Authority end, server 1) acquiring said ID associated to said mobile phone line of the user;
i. (Authority end, server 1) electronic signature of said document to be signed according to the above steps A-H according to claim 6, and
j. (Authority end, server 1) sending—via computer network—the signed electronic document.

11. A method according to claim 10, wherein said step f2 of making a phone call by means of a mobile phone associated to said user comprises the following steps:
F1. (Authority end, server1) sending a phone number or reference phone service—via a computer network 1—and optionally a one-time password,
F2. (user end) displaying said phone number or reference phone service USSD and optionally said one-time password,
F3. (user end) sending a call to said authentication phone number or a service request to said authentication sequence—via a mobile phone network —,
F4. (Authority end, served) optionally requesting the typing of said one-time password via mobile phone—via mobile phone network —,
F5. (user end) optionally typing said one-time password via mobile phone network
F6. (Authority end, served) optionally requesting the typing of a PIN code associated to the customer—via mobile phone network —,
F7. (user end) optionally typing said PIN code—via mobile phone network —,
F8. (Authority end, server1) checking the association of said mobile phone ID to said user and optionally of said PIN and/or said one-time password,

12. Technological infrastructure comprising a first remote server of an electronic signature Authority of a digital document comprising processing means configured for executing all the steps from A to H.

13. Technological infrastructure according to claim 12, comprising
a local computer in use to a user comprising first communication means to a first remote server,
said first remote server associated to said signature Authority and/or
a third-party authentication circuit comprising
a second remote server
a dedicated means (POS) to read said bank card and distinct second means for data connection to said second remote server
wherein said local computer comprises processing means configured for extracting said unique ID and send it to said first remote server and/or
a mobile phone associated to said user
wherein said first server comprises telephone interface means to said mobile phone to extract said unique ID associated to said mobile phone of said user,
wherein said local computer is configured for executing the steps a, b, e, f1, f2, h1 of claim 10,
and wherein said first remote server is configured for executing the steps c, d, e, h2, i, j of claim 10
and wherein said second remote server is configured for executing the step g1 of claim 10.

14. A computer program comprising program coding means adapted to execute all the steps of any one of claims 1 to 11, when said program is run on a computer.

15. Computer-readable means comprising a recorded program, said computer-readable means comprising program coding means adapted to execute all the steps of any one of claims 1 to 11, when said program is run on a computer.
